(19) United States
(12) Patent Application Publication
(10) Pub. No.: US 2022/0372287 A1
(43) Pub. Date: Nov. 24, 2022

(54) ISOCYANATE-REACTIVE COMPOSITION

(71) Applicant: Dow Global Technologies LLC, Midland, MI (US)

(72) Inventor: Weijun Zhou, Sugarland, TX (US)

(21) Appl. No.: 17/773,855

(22) PCT Filed: Jan. 19, 2021
(86) PCT No.: PCT/US2021/013876

§ 371 Date: May 3, 2022

Related U.S. Application Data
(60) Provisional application No. 62/966,571, filed on Jan. 28, 2020.

(51) Int. Cl. C08L 75/08; C08L 75/06; C08J 9/00; C08J 9/14

(52) U.S. Cl. CPC C08L 75/08; C08L 75/06; C08J 9/0061; C08J 9/141; C08L 2203/14; C08J 2203/14; C08J 2201/022; C08J 2375/06; C08J 2375/08; C08J 2401/02

(57) ABSTRACT

An isocyanate-reactive composition including: (i) at least one isocyanate-reactive compound; and (ii) a predetermined amount of at least one thixotropic modifier; and a foam-forming composition for producing a polyurethane or polyisocyanurate foam including: (A) at least one isocyanate component; and (B) at least one isocyanate-reactive component; wherein the at least one iso-cyanate-reactive component is the above isocyanate-reactive composition.

### FIELD

The present invention relates to an isocyanate-reactive composition, a method for preparing the above isocyanate-reactive composition, and a foam-forming formulation including the above isocyanate-reactive composition.

### INTRODUCTION

Polyurethane foams and methods of manufacturing polyurethane foams are well known. In general, the polyurethane foams are prepared by mixing reactive chemical components, such as an isocyanate component with an isocyanate-reactive component, in the presence of normally used additives such as suitable catalysts and suitable blowing agents. Typically, polyurethane foams are formed from two separate components, a first component commonly referred to as an “A-side” component; and a second component commonly referred to as a “B-side” component. The A-side and B-side components react when the two components come into contact with each other. For preparing traditional polyurethane foams, the first component, or the A-side, contains an isocyanate compound such as a di- or poly-isocyanate that has a high level of highly reactive isocyanate (N═C═O) functional groups on the molecule. The second component, or the B-side, contains an isocyanate-reactive compound having functional groups that are reactive with the isocyanate functional groups of the isocyanate compound in the A-side component. The isocyanate-reactive compounds are generally polyols having two or more hydroxyl groups. In some cases, mixtures of polyols are used to achieve desired foaming properties. The ratio of NCO group in the A-side to the overall hydroxyl group in the B-side is often varied to achieve different foam properties. For rigid polyurethane foams (PUR foams), the isocyanate index (or ISO index) which is the molar ratio of NCO group and OH group is typically higher than 1.0, e.g., rigid polyurethane foams have an ISO index of around 1.1 to 1.5, whereas for rigid polyisocyanurate foams (PIR foams), the ISO index is typically at least 1.5, and more often at least 1.8. The mass ratio of A-side to B-side depends on ISO index, NCO equivalent molecular weight of the A-side, and hydroxyl equivalent molecular weight of the B-side; and the mass ratio of A-side to B-side can vary from 4:1 to 1:4.

Heretofore, rigid polyurethane foams have been produced using various methods known in the art. For example, WO 2013/026809 A1 discloses a process for producing polyurethane by reacting a polyisocyanate with a polyol containing at least one thixotrope for solving the phase separation issue of incorporating a copolymer polyol in rigid foaming systems. The thixotrope specified in the above reference is based on a solution of polyamide comprising urea groups in an organic solvent.

WO 2017/155863 A1 discloses a rigid polyurethane foam including a reaction product of an isocyanate and a thixotropic composition that is isocyanate-reactive. This thixotropic composition is based on a combination of three polyether polyols with specific structural and rheological characteristics. The first of the three polyether polyols is an ortho-toluene diamine (o-TDA) type; the second of the three polyols is a polyol that requires a 4-5 functionality; and the third of the three polyols is a polyol that requires a 5-6 functionality. No thixotropic additive or filler is used nor taught in WO 2017/155863 A1.

US 2012/0183694 A1 discloses a spray foam formulation including a rheology modifier. The rheology modifier is used to resist mobility of the uncured formulation after the formulation is sprayed; and to allow the formulation to foam and cure. Different types of rheological modifiers are mentioned in US 2012/0183694 A1 and a modified nano-clay rheological modifier is disclosed as being the most effective for providing sag resistance. US 2012/0183694 A1 does not mention any use of rheological modifiers for thermal insulation property improvement or for mechanical friability improvement.

### SUMMARY

One aspect of the present invention is directed to an isocyanate-reactive composition including: (i) at least one isocyanate-reactive compound; and (ii) a predetermined amount of at least one thixotropic modifier, such as a microfibrillated cellulose.

In one embodiment, the at least one isocyanate-reactive compound, component (i), of the isocyanate-reactive composition is at least one polyester polyol compound.

In another embodiment, the at least one isocyanate-reactive compound, component (i), is at least one polyester polyol compound; and the polyester polyol compound is at least 30 pts based on the total weight of total isocyanate-reactive compounds at 100 parts by weight in the isocyanate-reactive composition.

In still another embodiment, the isocyanate-reactive composition includes: (i) the at least one isocyanate-reactive compound; and (ii) the at least one thixotropic modifier, wherein the at least one thixotropic modifier is a cellulose ether; and the cellulose ether is methylcellulose, ethyl cellulose, hydroxyethyl cellulose and mixtures thereof.

In yet another embodiment, the at least one thixotropic modifier, component (ii), is from 0.01 pts to 5 pts based on the total weight of total isocyanate-reactive compounds at 100 parts by weight in the isocyanate-reactive composition.

Another aspect of the present invention is directed to a process for producing the above isocyanate-reactive composition including the step of mixing (i) at least one isocyanate-reactive compound; and (ii) a predetermined amount of at least one thixotropic modifier, such as microfibrillated cellulose.

Still another aspect of the present invention is directed to a foam-forming composition for producing a polyurethane foam or a polyisocyanurate foam including: (A) at least one isocyanate component; and (B) at least one isocyanate-reactive component; wherein the at least one isocyanate-reactive component, component (B), includes the above isocyanate-reactive composition. The foam-forming composition including the isocyanate-reactive composition, in component (B), is particularly useful for making a polyurethane rigid (PUR) foam, polyisocyanurate rigid (PIR) foam, or a combination of both a PIR foam and a PUR foam with improved thermal insulation performance and mechanical toughness.

Yet another aspect of the present invention is directed to a process for producing a foam-forming composition for producing a polyurethane foam or polyisocyanurate foam including admixing: (A) at least one isocyanate component; and (B) at least one isocyanate-reactive component; wherein the at least one isocyanate-reactive component includes the above isocyanate-reactive composition.

Even still another aspect of the present invention is directed to a rigid polyurethane or polyisocyanurate foam made from the above foam-forming composition.

### DETAILED DESCRIPTION

“Thixotropic modifier” or “thixotrope” herein means an organic or inorganic material which exhibits a stable form at rest but becomes fluid when agitated. A finite time is needed for a thixotropic fluid to attain equilibrium viscosity when subject to a steep change in shear rate. Such behavior is commonly referred to as thixotropic flow as characterized by a time dependent shear thinning property. Many gels and colloids are thixotropic materials. Thixotropy arises because particles or structured solutes require time to organize as explained by Mewis and Wagner, “Thixotropy”. Advances in Colloid and Interface Science. 147-148: 214-227 (2009).

“Fibril” herein means a structural material with a large aspect ratio of length-to-diameter like fibers or filaments. Fibrils tend to have diameters ranging from 10 nm to 100 nm. The fibrils are not usually found alone but rather as parts of greater hierarchical structures commonly found in biological systems.

“Microfibrillated cellulose” (herein abbreviated “MFC”) is a cellulose polymer that is a naturally occurring linear polymer made of repeating units of glucose. Single polymers are stacked together forming fibrils, and these fibrils stack together again to form the cellulose fiber structure that is present in nature. This supramolecular structure consists of both crystalline and amorphous regions. MFC is also called nanocellulose, cellulose nanofibers (CNF), or cellulose nanocrystal (CNC).

As used throughout this specification, the abbreviations given below have the following meanings, unless the context clearly indicates otherwise: “=” means “equal to”; @ means “at”; “<” means “less than”; “>” means “greater than”; “≤” means “less than or equal to”; “≥” means “greater than or equal to”; g=gram(s); mg=milligram(s); pts=parts by weight; kg=kilograms; g/cc=gram(s) per cubic centimeter; kg/m³=kilograms per cubic meter; g/eq=grams per equivalent weight; g/mol=gram(s) per mole; mg KOH/g=milligrams of potassium hydroxide per gram which is the acid value of a chemical substance measured as the number of milligrams of potassium hydroxide required to neutralize one gram of chemical substance; L=liter(s); mL=milliliter(s); g/L=grams per liter; Mw=Mass molecular weight; m=meter(s); μm=microns: mm=millimeter(s); cm=centimeter(s); nm=nanometer(s); min=minute(s); s=second(s); rad/s=radian(s) per second; ms=milliseconds; hr=hour(s); mm/min=millimeter(s) per minute; m/s=meter(s) per second; ° C.=degree(s) Celsius; mPa·s=millipascals-seconds; mPa=megapascals; kPa=kilopascals; GPa=gigapascals; Pa·s/m²=pascals-seconds per meter squared; cN=centinewton; rpm=revolution(s) per minute; mm²=millimeter squared; mW/m-K=milliwatts per meter-Kelvin; g/10 min=gram(s) per 10 minutes; %=percent; eq %=equivalent percent; vol %=volume percent; and wt %=weight percent.

Unless stated otherwise, all percentages, parts, ratios, and like amounts, are defined by weight. For example, all percentages stated herein are weight percentages (wt %), unless otherwise indicated.

Temperatures are in degrees Celsius (° C.), and “ambient temperature” means between 20° C. and 25° C., unless specified otherwise.

As aforementioned, polyurethane foams or polyisocyanurate foams are formed by reacting, a first component (A) commonly referred to as an “A-side” component; and a second component (B) commonly referred to as a “B-side” component. The A-side component contains at least one isocyanate compound such as a di- or poly-isocyanate; and the B-side component contains at least one isocyanate-reactive compound having functional groups that are reactive with the isocyanate functional groups of the isocyanate compound(s) in the A-side component.

One broad embodiment of the present invention includes a B-side component that comprises an isocyanate-reactive composition including a mixture of: (Bi) at least one isocyanate-reactive compound; and (Bii) a predetermined amount of at least one thixotropic modifier. The above mixture of compounds (Bi) and (Bii) forming the isocyanate-reactive composition can then be used as the B-side component of a polyurethane or polyisocyanurate foam-forming composition including a reactive mixture of an A-side component and B-side component.

The isocyanate-reactive composition for making a rigid polyurethane or polyisocyanurate foam with improved thermal insulation performance and mechanical toughness includes a thixotropic modifier, such as MFC, wherein in one general embodiment: (1) the amount of thixotropic modifier is from 0.01 pts to 5 pts, based on the total weight of isocyanate-reactive compounds at 100 pts; (2) the average functionality of isocyanate-reactive groups is no more than 3, and more preferably in the range of from 1.8 to 2.7; and (3) the ratio of viscosity measured at 0.1 rad/s and 100 rad/s on the isocyanurate reactive composition at 60° C. is greater than 10, but no more than 300.

In general, the thixotropic modifier can be introduced into the isocyanate-reactive composition, component (B), in various forms such as a pure material (for example, as a solid powder) or as part of a solution, a dispersion, or a paste; or any combinations thereof to provide the amount of thixotropic modifier in component (B) in the aforementioned range of from 0.01 pts to 5 pts, based on the total weight of isocyanate-reactive compounds at 100 pts.

The rigid polyurethane or polyisocyanurate foam prepared from the reactive mixture of: (A) a polymeric isocyanate with an isocyanate index of ≥1.0 in one embodiment, and lying within the range of from 1.1 to 7 in another embodiment; (B) the above isocyanate-reactive composition; and (C) optionally, an auxiliary or additional component(s) consisting of a surfactant, foaming catalyst, physical or chemical blowing agent, flame retardant additive, nucleating agent, and the like; beneficially exhibits a low thermal conductivity and improved mechanical toughness. In a preferred embodiment, the thermal conductivity of the foam is ≤19.5 mW/m-K at 10° C. and the mechanical friability of the foam is ≤10%.

If desired, the optional auxiliary or additional components can be added to the A-side component and/or the B-side component of the foam-forming composition. In a preferred embodiment, the optional auxiliary or additional components can include, for example, (C) a blowing agent and/or a catalyst. In some embodiments, auxiliary components such as urethane catalysts, trimerization catalysts, surfactants, reactive or non-reactive diluents, physical or chemical blowing agents, antioxidants, flame retardant additives, pigments, adhesion promoter, and the like, can be used in the present invention.

The isocyanate component, component (A) (or the A-side component) of the present invention, can include, for example, one or more isocyanate compounds including for example a polyisocyanate. As used herein, “polyisocyanate” refers to a molecule having an average of greater than 1.0 isocyanate groups/molecule, e.g. an average functionality of greater than 1.0.

The isocyanate compound useful in the present invention may be an aliphatic polyisocyanate, a cycloaliphatic polyisocyanate, an araliphatic polyisocyanate, an aromatic polyisocyanate, or combinations thereof. Examples of isocyanates useful in the present invention include, but are not limited to, polymethylene polyphenylisocyanate; toluene 2,4-/2,6-diisocyanate (TDI); methylenediphenyl diisocyanate (MDI); polymeric MDI; triisocyanatononane (TIN); naphthyl diisocyanate (NDI); 4,4′-diisocyanatodicyclohexyl-methane; 3-isocyanatomethyl-3,3,5-trimethylcyclohexyl isocyanate (isophorone diisocyanate IPDI); tetramethylene diisocyanate; hexamethylene diisocyanate (HDI); 2-methyl-pentamethylene diisocyanate; 2,2,4-trimethylhexamethylene diisocyanate (THDI); dodecamethylene diisocyanate; 1,4-diisocyanatocyclohexane; 4,4′-diisocyanato-3,3′-dimethyl-dicyclohexylmethane; 4,4′-diisocyanato-2,2-dicyclohexylpropane; 3-isocyanatomethyl-1-methyl-1-isocyanatocyclohexane (MCI); 1,3-diisooctylcyanato-4-methylcyclohexane; 1,3-diisocyanato -2-methylcyclohexane; and combinations thereof, among others. In addition to the isocyanates mentioned above, partially modified polyisocyanates including uretdione, isocyanurate, carbodiimide, 6retoneimine, allophanate or biuret structure, and combinations thereof, among others, may be utilized in the present invention.

The isocyanate may be polymeric. As used herein “polymeric”, in describing the isocyanate, refers to high molecular weight homologues and/or isomers. For instance, polymeric methylene diphenyl isocyanate refers to a high molecular weight homologue and/or an isomer of methylene diphenyl isocyanate.

In another embodiment, the isocyanate component useful in the present invention can include an isocyanate prepolymer. The isocyanate prepolymer is known in the art; and in general, is prepared by reacting (1) at least one isocyanate compound and (2) at least one polyol compound.

As aforementioned, the isocyanate may have an average functionality of greater than 1.0 isocyanate groups/molecule. For instance, the isocyanate may have an average functionality of from 1.75 to 3.50. All individual values and subranges from 1.75 to 3.50 are included; for example, the isocyanate may have an average functionality from a lower limit of 1.75, 1.85, or 1.95 to an upper limit of 3.50, 3.40 or 3.30.

The isocyanate may have an isocyanate equivalent weight of from 80 g/eq to 300 g/eq. All individual values and subranges from 80 g/eq to 300 g/eq are included; for example, the isocyanate may have an isocyanate equivalent weight from a lower limit of 80 g/eq, 90 g/eq, or 100 g/eq to an upper limit of 300 g/eq, 290 g/eq, or 280 g/eq.

The isocyanate used in the present invention may be prepared by a known process. For instance, a polyisocyanate may be prepared by phosgenation of corresponding polyamines with formation of polycarbamoylchlorides and thermolysis thereof to provide the polyisocyanate and hydrogen chloride; or in another embodiment, the polyisocyanate may be prepared by a phosgene-free process, such as by reacting the corresponding polyamines with urea and alcohol to give polycarbamates, and thermolysis thereof to give the polyisocyanate and alcohol, for example.

The isocyanate used in the present invention may be obtained commercially. Examples of commercial isocyanates useful in the present invention include, but are not limited to, polyisocyanates under the trade names VORANATE™, PAPI™, and ISONATE™, such as VORANATE™ M 220, and PAPI™ 27, all of which are available from The Dow Chemical Company, among other commercial isocyanates.

The amount of isocyanate compound used in the reactive foam-forming composition of the present invention can be, for example, from 20 wt % to 80 wt % in one embodiment, from 25 wt % to 75 wt % in another embodiment and from 30 wt % to 70 wt % in still another embodiment.

The isocyanate-reactive component, component (B) (or the B-side component) of the present invention, includes an isocyanate-reactive composition which is a mixture, combination or blend of: (Bi) at least one isocyanate-reactive compound; and (Bii) a predetermined amount of at least one thixotropic modifier.

The isocyanate-reactive compound (Bi) can be, for example, one or more compounds reactive with the isocyanate compound present in the A-side component. The isocyanate-reactive compound includes, for example, a polyol compound comprising a polyether polyol, a polyester polyol, a polyester ether polyol, a polycarbonate polyol, a polyacrylate polyol, a polycaprolactone polyol, a natural oil polyol, and blends thereof. In a preferred embodiment, the polyol compound can be selected from the group consisting of polyether polyols, polyester polyols, polyester ether polyols, and mixtures thereof. The polyol compound (Bi) may also include other polyols such as alkylene glycols chain extenders. The polyol compound (Bi), may include for example a single polyol in one embodiment; or a mixture or blend of two or more different polyols. As used herein, “polyol” refers to a compound having an average hydroxyl functionality of 1.8 or greater, such as diols, triols, tetrols, and the like. The functionality (average number of isocyanate-reactive groups/molecule) of the polyol compound can be, for example at least 1.8 in one embodiment and at least 2.0 in another embodiment.

A number of various polyols may be utilized for the polyol compound, such as those discussed herein, among other polyols known to those skilled in the art. For example, the polyol compound (Bi) useful in the present invention may include one or more embodiments of a polyol compound such as an aromatic polyester polyol; a triol or a polyether triol such as a glycerol; a sucrose/glycerine-initiated polyether polyol; a sorbitol-initiated polyether polyol; an amine-initiated polyol; and mixtures thereof.

In general, the average hydroxyl functionality of the polyol compound useful in the present invention, such as those described above, can range from a low as 1.8 to as high as 7.5. For example, the aromatic polyester polyol may have an average hydroxyl functionality from 1.8 to 3.0; and the sucrose/glycerine-initiated polyether polyol may have an average hydroxyl functionality of from 3.5 to 7.5. Therefore, the average hydroxyl functionality of the polyol compound used in the present invention can range from 1.8 to 7.5. All individual values and subranges from 1.8 to 7.5 are included; for example, the polyol compound may have an average hydroxyl functionality from a lower limit of 1.8, 2.0, 3.0, or 3.5 to an upper limit of 7.5, 7.0, 6.5, or 6.0.

In general, the polyol compound may have an average hydroxyl number ranging from 75 mg KOH/g to 650 mg KOH/g. All individual values and subranges from 75 mg KOH/g to 650 mg KOH/g are included; for example, the polyol compound may have an average hydroxyl number from a lower limit of 75 mg KOH/g, 80 mg KOH/g, 100 mg KOH/g, 150 mg KOH/g, or 175 mg KOH/g to an upper limit of 650 mg KOH/g, 600 mg KOH/g, 500 mg KOH/g, or 450 mg KOH/g.

In general, the polyol compound may have a number average molecular weight of from 100 g/mol to 1,500 g/mol. All individual values and subranges of from 100 g/mol to 1,500 g/mol are included; for example, the polyol compound may have a number average molecular weight from a lower limit of 100 g/mol, 150 g/mol, 175 g/mol, or 200 g/mol to an upper limit of 1,500 g/mol, 1250 g/mol, 1,000 g/mol, or 900 g/mol.

In general, the polyol compound may have a hydroxyl equivalent molecular weight from 50 g/eq to 750 g/eq. All individual values and subranges from 50 g/eq to 750 g/eq are included; for example, the polyol compound may have a hydroxyl equivalent molecular weight from a lower limit of 50 g/eq, 90 g/eq, 100 g/eq, or 110 g/eq to an upper limit of 350 g/eq, 300 g/eq, 275 g/eq, or 250 g/eq.

As used herein “aromatic polyester polyol” refers to a polyester polyol including an aromatic ring. As an example, the aromatic polyester polyol may be phthalic anhydride diethylene glycol polyester or may be prepared from the use of aromatic dicarboxylic acid with glycols. The aromatic polyester polyol may be a hybrid polyester-polyether polyol, e.g., as discussed in International Publication No. WO 2013/053555.

In one embodiment, the aromatic polyester polyol may be prepared using known equipment and reaction conditions. In another embodiment, the aromatic polyester polyol may be obtained commercially. Examples of commercially available aromatic polyester polyols include, but are not limited to, a number of polyols sold under the trade name STEPANPOL™, such as STEPANPOL™ PS-2352, available from Stepan Company, among others.

One or more embodiments of the present invention may include a polyol compound that includes a triol. The triol may have an average hydroxyl functionality of 3.0. The triol may be a polyether or a polyester triol. For example, the triol may be a glycerol.

In one embodiment, the triol may be prepared using known equipment and reaction conditions. In another embodiment, the triol may be obtained commercially. Examples of commercially available triols include, but are not limited to, a number of polyols sold under the trade name VORATEC™, such as VORATEC™ SD 301, available from The Dow Chemical Company, among others.

One or more embodiments of the present invention may include polyol compounds that include a sucrose/glycerine-initiated polyether polyol. The sucrose/glycerine-initiated polyether polyol may include structural units derived from another alkylene oxide, e.g., ethylene oxide. The sucrose/glycerine-initiated polyether polyol may include structural units derived from styrene—acrylonitrile, polyisocyanate, and/or polyurea.

In one embodiment, the sucrose/glycerine-initiated polyether polyol may be prepared using known equipment and reaction conditions. For instance, the sucrose/glycerine-initiated polyether polyol may be formed from reaction mixtures including sucrose, propylene oxide, and glycerin. One or more embodiments provide that the sucrose/glycerine-initiated polyether polyol is formed via a reaction of sucrose and propylene oxide. In another embodiment, the sucrose/glycerine-initiated polyether polyol may be obtained commercially. Examples of commercially available sucrose/glycerine-initiated polyether polyols include, but are not limited to, a number of polyols sold under the trade name VORANOL™, such as VORANOL™ 360, VORANOL™ 490, and VORANOL™ 280 available from The Dow Chemical Company, among others.

One or more embodiments of the present invention may include polyol compounds that include a sorbitol-initiated polyether polyol. In one embodiment, the sorbitol-initiated polyether polyol may be prepared using known equipment and reaction conditions. For instance, the sorbitol-initiated polyether polyol may be formed from reaction mixtures including sorbitol and alkylene oxides, e.g., ethylene oxide, propylene oxide, and/or butylene oxide. The sorbitol-initiated polyether polyol may be capped, e.g., the addition of the alkylene oxide may be staged to preferentially locate or cap a particular alkylene oxide in a desired position of the polyol.

In another embodiment, the sorbitol-initiated polyether polyol may be obtained commercially. Examples of commercially available sorbitol-initiated polyether polyols include, but are not limited to, a number of polyols sold under the trade name VORANOL™, such as VORANOL™ RN 482, available from The Dow Chemical Company, among others.

One or more embodiments of the present invention may include polyol compounds that include an amine-initiated polyol. The amine-initiated polyol may be initiated from aromatic amine or aliphatic amine, for example, the amine-initiated polyol may be an ortho toluene diamine (o-TDA) initiated polyol, an ethylenediamine initiated polyol, a diethylenetriamine, triisopropanolamine initiated polyol, or a combination thereof, among others.

In one embodiment, the amine-initiated polyol may be prepared using known equipment and reaction conditions. For instance, the amine-initiated polyol may be formed from reaction mixtures including aromatic amines or aliphatic amines and alkylene oxides, e.g., ethylene oxide and/or butylene oxide, among others. The alkylene oxides may be added into an alkoxylation reactor in one step or via several steps in sequence, wherein in each step, a single alkylene oxide or a mixture of alkylene oxides may be used.

In general, the concentration of the isocyanate-reactive compound, such as the polyol compound (Bi), used in the isocyanate-reactive composition, component (B), of the reactive foam-forming composition of the present invention can be, for example, from 95 wt % to 99.99 wt % in one embodiment, from 95 wt % to 99.9 wt % in another embodiment, from 95 wt % to 99 wt % in still another embodiment, from 97 wt % to 99 wt % in yet another embodiment, and from 97.5 wt % to 99 wt % in even still another embodiment, based on the total weight of the components in the isocyanate-reactive composition, component (B).

The thixotropic modifier compound (Bii) used in the isocyanate-reactive composition, component (B), of the reactive foam-forming composition of the present invention can be, for example, one or more compounds including for example a MCF; nanocellulose; cellulose ether materials such as methylcellulose, ethyl cellulose, hydroxyethyl cellulose and the like; starch; associative polymers; and mixtures thereof.

Inorganic compounds such as silica and organo-modified sheet silicates may also be used as a thixotrope. Incorporation of inorganic thixotropes into the isocyanate-reactive composition may be a bit more difficult than MCF type materials as cellulose materials interacts with polyols more favorably.

In one preferred embodiment, the thixotropic modifier compound can include MFC, hydroxyethyl cellulose, nanocrystalline cellulose, and mixtures thereof.

In another preferred embodiment, the thixotropic modifier compound can include commercially available compounds such as CELLOSIZE™ Hydroxyethyl Cellulose (HEC) (available from The Dow Chemical Company); MFC paste in water such as EXILVA™ P01V and EXILVA™ F01V (products by Borregaard); and mixtures thereof.

The MFC useful in the present invention can be prepared, for example, from any cellulose source material such as wood pulp. In a preferred embodiment, wood pulp is used to prepare the MFC. The nanocellulose fibrils may be isolated from the wood-based fibers using, for example, mechanical methods which expose the pulp to high shear forces, ripping the larger wood fibers apart into nanofibers. The mechanical methods and equipment for forming the MFC can include, for example, high-pressure homogenizers, ultrasonic homogenizers, grinders or microfluidizers. In a preferred embodiment, homogenizers are used to delaminate the cell walls of the fibers and liberate the nanosized fibrils forming the MFC.

MFC is insoluble in water, has a high aspect ratio, and has a high surface area compared to traditional cellulose fibers. In aqueous suspensions, MFC will create particulate fibril networks. MFC consist of long interconnected fibrils, and the resulting flexible MFC particle creates a strong network with a high efficiency of “holding” water.

MFC paste, such as EXILVA™, is a three-dimensional network of cellulose microfibrils suspended in water. The microfibrils form flexible aggregates with a high surface area allowing for very efficient interactions with the surroundings/matrix. This can be an advantageous when using MFC as a rheological modifier.

MFC, which comprises both crystalline and amorphous areas, has impressive mechanical properties such as high modulus and tensile strength. Nano-sized crystalline cellulose materials have been measured to exhibit a Young's modulus of 150 GPa and a tensile strength of 10 GPa. The use of the MFC in an application will depend on the type of end use application and the desired function in a particular product formulation. However, the MFC can provide a great opportunity for developing new formulations in various fields, contributing novel properties to a product, and providing a green profile of a product.

The predetermined amount of thixotropic modifier compound used in component (B) of the reactive composition of the present invention can be, for example, from 0.01 pts to 5 pts in one embodiment, from 0.1 pts to 4 pts in another embodiment, from 0.2 pts to 3 pts in still another embodiment and from 0.5 pts to 2.5 pts in yet another embodiment, based on the total weight of the polyol compounds at 100 pts in the isocyanate-reactive composition, component (B).

The average functionality of isocyanate-reactive groups in component (B) of the present invention is no more than 3.0 in one embodiment, in the range of from 1.8 to 2.7 in another embodiment, in the range of from 2.0 to 2.7 in still another embodiment, and in the range of from 2.0 to 2.5 in yet another embodiment.

The ratio of viscosity measured on the isocyanate-reactive composition at 60° C., i.e. the combination of: (Bi) the at least one isocyanate-reactive compound; and (Bii) the at least one thixotropic modifier, at the following two shear rates: (1) 0.1 rad/s and (2) 100 rad/s, is from greater than 10 to less than 300 in one embodiment, from 15 to 250 in another embodiment, and from 20 to 200 in still another embodiment. When the viscosity ratio is too small (e.g., smaller than 10), the viscosity of the isocyanate-reactive composition is not sufficiently high to be effective on enhancing bubble stability during the early stage of foaming process. On the contrary, when the viscosity ratio is too large (e.g., greater than 300), the viscosity of the isocyanate-reactive composition at quiescent condition is too high for gas bubbles to expand into a desirable low-density foam.

In addition to the above components (A) and (B) present in the foam-forming reactive mixture, the reactive mixture of the present invention may also include other additional optional auxiliary components, compounds, agents or additives, as component (C); and such optional component (C) may be added to the reactive mixture with any of components (A) and/or (B); or as a separate addition as component (C). The optional auxiliary components, compounds, agents or additives that can be used in the present invention can include one or more optional compounds known in the art for their use or function. For example, the optional component (C) can include expandable graphite, physical or chemical blowing agent, foaming catalyst, flame retardant, emulsifier, antioxidant, surfactant, liquid nucleating agents, solid nucleating agents, Ostwald ripening retardation additives, pigment, solvents including further a solvent selected from the group consisting of ethyl acetate, methyl ether ketone, toluene, and mixtures of two or more thereof; and mixtures of two or more of the above optional additives.

The amount of optional compound used to add to the reactive mixture of the present invention can be, for example, from 0 pts to 50 pts, based on 100 pts of total polyols amount in the B-side in one embodiment, from 0.1 to 40 pts in another embodiment and from 1 pts to 35 pts in still another embodiment. For example, in one embodiment, the usage amount of a physical blowing agent, when used, can be from 1 pts to 40 pts, based on 100 pts of total polyols amount in the B-side. In another embodiment, the usage amount of a chemical blowing agent, when used, can be from 0.1 pts to 10 pts, based on 100 pts of total polyols amount in the B-side. In still another embodiment, the usage amount of a flame-retardant additive, when used, can be from 5 pts to 25 pts, based on 100 pts of total polyols amount in the B-side. In yet another embodiment, the usage amount of a surfactant, when used, is typically from 0.1 pts to 10 pts, based on 100 pts of total polyols amount in the B-side. In even still another embodiment, the usage amount of a foaming catalyst, when used, is from 0.05 pts to 5 pts, based on 100 pts of total polyols amount in the B-side. And, in a general embodiment, the usage amount of other additives, when used, can be from 0.1 pts to 5 pts, based on 100 pts of total polyols amount in the B-side.

The isocyanate-reactive composition, component (B), disclosed herein may include a catalyst, e.g., the catalyst may be added to the isocyanate-reactive composition. The catalyst may be a blowing catalyst, a gelling catalyst, a trimerization catalyst, or combinations thereof. As used herein, blowing catalysts and gelling catalysts, may be differentiated by a tendency to favor either the urea (blow) reaction, in the case of the blowing catalyst, or the urethane (gel) reaction, in the case of the gelling catalyst. A trimerization catalyst may be utilized to promote the isocyanurate reaction in the compositions.

Examples of blowing catalysts include catalysts that may tend to favor the blowing reaction including, but are not limited to, short chain tertiary amines or tertiary amines containing an oxygen. The amine-based catalyst may not be sterically hindered. For instance, blowing catalysts include bis-(2-dimethylaminoethyl)ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others. An example of a commercial blowing catalyst is POLYCAT™ 5, from Evonik, among other commercially available blowing catalysts.

Examples of gelling catalysts include catalysts that may tend to favor the gel reaction, including, but are not limited to, organometallic compounds; cyclic tertiary amines; long chain amines such as those that contain several nitrogen atoms; and combinations thereof. Organometallic compounds include, for example, organotin compounds such as tin(II) salts of organic carboxylic acids including for example tin(II) diacetate, tin(II) dioctanoate, tin(II) diethylhexanoate, and tin(II) dilaurate; dialkyltin(IV) salts of organic carboxylic acids including for example dibutyltin diacetate, dibutyltin dilaurate, dibutyltin maleate and dioctyltin diacetate; and mixtures thereof. Bismuth salts of organic carboxylic acids such as bismuth octanoate may also be utilized as the gelling catalyst. Cyclic tertiary amines and/or long chain amines include dimethylbenzylamine, triethylenediamine, and combinations thereof, and combinations thereof. Examples of a commercially available gelling catalysts include POLYCAT™ 8 and DABCO™ T-12 from Evonik, among other commercially available gelling catalysts.

Examples of trimerization catalysts include PMDETA-N,N,N′,N″,N″-pentamethyldiethylenetriamine; N,N′,N″-tris(3-dimethylaminopropyl)hexahydro-S-triazine; N,N-dimethylcyclo-hexylamine; 1,3,5-tris(N,N-dimethylaminopropyl)-s-hexahydrotriazine; [2,4,6-tris (dimethylaminomethyl) phenol]; potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 carbon atoms to 20 carbon atoms; and combinations thereof, among others. Some commercially available trimerization catalysts include DABCO™ TMR-2, DABCO™ TMR-7, DABCO™ K 2097; DABCO™ K15, POLYCAT™ 41, and POLYCAT™ 46, all of which are available from Evonik, among other commercially available trimerization catalysts.

The amount of catalyst, when used, may be from 0.05 pts of the isocyanate-reactive composition based upon 100 pts of total polyols (parts) to 5.0 pts. All individual values and subranges from 0.05 pts to 5 pts are included; for example, the catalyst may be from a lower limit of 0.05 pts, 0.1 pts, or 0.3 pts to an upper limit of 5.0 pts, 4 pts, or 3.5 pts of the isocyanate-reactive composition based upon 100 pts of total isocyanate-reactive compounds in the isocyanate-reactive composition.

A variety of conventional blowing agents can be used. For example, the blowing agent can be one or more of water, various hydrocarbons, various hydrofluorocarbons, various hydrofluoroolefins, formic acid, a variety of chemical blowing agents that produce nitrogen or carbon dioxide under the conditions of the foaming reaction, and the like; and mixtures thereof.

The chemical blowing agent such as water can be used alone or mixed with other chemical and/or physical blowing agents. Physical blowing agents can be used such as low-boiling hydrocarbons. Examples of such used liquids are alkanes, such as heptane, hexane, n- and iso-pentane, technical grade mixtures of n- and isopentanes and n- and iso-butane and propane, cycloalkanes such as cyclopentane and/or cyclohexane, ethers, such as furan, dimethyl ether and diethyl ether, ketones such as acetone and methyl ethyl ketone, alkyl carboxylates, such as methyl formate, dimethyl oxalate and ethylene lactate and halogenated hydrocarbons such as methylene chloride, Dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane, pentafluoropropane, heptafluoropropane and hexafluorobutene, SOLSTICE™ LBA from Honeywell. Mixtures of these low boiling liquids with each other and/or with other substituted or unsubstituted hydrocarbons can also be used. Also suitable are organic carboxylic acids such as formic acid, acetic acid, oxalic acid, Ricinolsäu-Re and carboxyl-containing compounds.

The isocyanate-reactive composition, component (B), disclosed herein may include a surfactant, e.g., the surfactant may be added to the isocyanate-reactive composition. The surfactant may be a cell-stabilizing surfactant. Examples of surfactants useful in the present invention include silicon-based compounds such as organosilicone-polyether copolymers, such as polydimethylsiloxane-polyoxyalkylene block copolymers, e.g., polyether modified polydimethyl siloxane, and combinations thereof. Examples of surfactants include non-silicone based organic surfactants such as VORASURF™ 504, available from The Dow Chemical Company. Surfactants are available commercially and include those available under trade names such as NIAXT™, such as NIAX™ L 6988; and TEGOSTAB™, such as TEGOSTAB™ B 8462; among others.

The amount of surfactant, when used, may be from 0.1 pts to 10.0 pts of the isocyanate-reactive composition based upon 100 pts of a combination of the total polyols of the isocyanate-reactive composition. All individual values and subranges from 0.1 pts to 10.0 pts are included; for example, the surfactant may be from a lower limit of 0.1 pts, 0.2 pts, or 0.3 pts to an upper limit of 10.0 pts, 9.0 pts, 7.5, or 6 pts of the isocyanate-reactive composition based upon 100 pts of a combination of the total polyols present in the isocyanate-reactive composition.

In a broad embodiment, the process for producing the isocyanate-reactive composition, component (B) (or the B-side component) of the present invention, includes the step of mixing, combining or blending: (Bi) at least one isocyanate-reactive compound selected from the one or more compounds described above; (Bii) a predetermined amount of at least one thixotropic modifier compound selected from the one or more compounds described above; and (Biii) optional components, if desired. The above compounds (Bi)-(Biii) are mixed together under process conditions such that the above compounds are thoroughly mixed together to form a uniform isocyanate-reactive composition. The ingredients that make up the isocyanate-reactive composition may be mixed together by any known mixing process and equipment. The order of mixing the ingredients to produce the isocyanate-reactive composition is not critical; and two or more compounds can be mixed together followed by addition of any other optional ingredients. For example, in a preferred embodiment, the thixotropic additive compound (Bi) is first pre-mixed with the isocyanate-reactive compound (Bii) followed by mixing of any optional compounds (Biii) to form the B-side component.

In another broad embodiment, the process for producing a polyurethane or polyisocyanurate foam-forming reactive composition of the present invention generally includes mixing: (A) at least one isocyanate component as the A-side component; (B) at least one isocyanate-reactive component as the B-side component; and (C) optional components, if desired. The components (A)-(C) above are mixed together under process conditions such that the above reactive components are thoroughly mixed together to form a uniform reactive polyurethane or polyisocyanurate foam-forming composition.

In one preferred embodiment for example, the process to produce the polyurethane or polyisocyanurate reactive foam-forming composition of the present invention includes the following steps of: (I) providing a reactor vessel or container to receive the above components (A)-(C) to form a reaction mixture in the vessel; (II) adding the above components (A)-(C) to the reactor vessel; (III) mixing the components (A)-(C) in the reactor vessel or container under process conditions to form a homogeneous reaction mixture; and (IV) allowing the above components (A)-(C) to react to form a polyurethane or polyisocyanurate foam.

The ingredients that make up the foam-forming reactive composition may be mixed together by any known urethane foaming mixing process and equipment. Typically, an impingent mixer is used for mixing the A-side and B-side as well as the additional optional components. The order of mixing the ingredients to produce the polyurethane or polyisocyanurate reactive foam-forming composition is not critical; and two or more compounds can be mixed together followed by addition of any other optional ingredients. For example, in a general embodiment, the preparation of the foam-forming composition includes providing at least one isocyanate component (A) such as one or more polyisocyanate compound(s) as part of the above A-side component of the foam-forming composition; providing at least one isocyanate-reactive component (B) such as one or more polyol compound(s) as part of the above B-side component of the foam-forming composition; and admixing the at least one polyisocyanate compound (A-side), the at least one polyol compound (B-side); and any optional compounds such as a blowing agent, a catalyst and/or a surfactant, as component (C), to form the foam-forming composition.

In preparing the foam-forming composition, the A-side containing the polyisocyanate compound(s) and the B-side containing the polyol compound(s) can be separately and individually prepared; and then mixed together with foaming equipment such as a high-pressure impingent mixer. The A-side and/or the B-side can include any of a number of optional components, compounds, agents, ingredients, or additives. In some embodiments, one or more of the other optional compounds (ingredients) of the foam-forming composition such as the blowing agent, the surfactant and/or the catalyst, component (C), can be added to the foam-forming composition via: (1) the polyisocyanate compound (A-side); (2) the polyol compound (B-side); or (3) both the A-side and the B-side. In other embodiments, the blowing agent, the surfactant, and/or the catalyst, component (C), can be added to the A-side and/or B-side before the A-side and B-side are mixed together; or simultaneously as the A-side and B-side are mixed together. For instance, foaming additives, as component (C), such as catalysts and surfactants are sometimes pre-mixed into the B-side before the pre-mixed B-side component is mixed with the A-side. A blowing agent is often times pre-mixed into the B-side as well. In other embodiments, sometimes the blowing agent is mixed online as a separate stream during the foaming process.

As aforementioned, in one embodiment, the A-side and the B-side of the foam-forming composition are separately and individually prepared with the ingredients (A)-(C). In a preferred embodiment, all of the components, ingredients and the optional ingredients, if any; can be mixed together as an isocyanate component premix (A-side) and a polyol component premix (B-side) in the desired concentrations to prepare the final polyurethane or polyisocyanurate foam-forming composition.

In one general embodiment, the mass ratio of the A-side (polyisocyanate side) to the B-side (polyol side), forming the reactive foam-forming composition, can be generally at a ratio from X:1 to Y:1, wherein X can be a value of less than 1 and Y can be in the range of from 1 to 4. For example, in one preferred embodiment the mass ratio of A-side:B-side is from 0.25:1 to 4:1 by weight. In terms of the mole ratio of the isocyanate groups (i.e., the number of NCO groups) in the A-side to the isocyanate-reactive groups (i.e. the number of OH groups) in the B-side, the mole ratio can be in the range of from 1.1:1 to 6:1 in one embodiment and from 1.5:1 to 5:1 in another embodiment.

The mixing of the components can be carried out at a temperature of from 5° C. to 80° C. in one embodiment; from 10° C. to 60° C. in another embodiment; and/or from 15° C. to 50° C. in still another embodiment.

The resulting foam-forming composition produced according to the above described process, is advantageously used to prepare a rigid foam of the present invention such as a PUR foam, a PIR foam, or a combination of both a PIR foam and a PUR foam. Conventional process and equipment can be used to make the rigid foam. In a general embodiment, for example, the process of the present invention for producing a polyurethane foam product includes the steps of: (I) mixing the A-side component including at least one isocyanate compound such as a polyisocyanate; and the B-side component including at least one isocyanate-reactive compound such as a polyol compound; and any optional components as desired to form a reactive foam-forming composition; and (II) once the components are mixed together, allowing the resulting mixture to react to form a polyurethane foam or a polyisocyanurate foam. The reactive mixture is allowed to react to form a foam and then cured; and if needed, heat can be applied to the reaction mixture to speed up the curing reaction. For example, the resulting reactive blend is then subjected to conditions sufficient to allow the foaming reaction to occur and to cure the reactive formulation to form a rigid foam. For example, the mixture of the A-side and B-side can be heated at an elevated temperature for a desirable amount of time to cure the foam-forming composition. The components can be heated at a temperature of from 25° C. to 80° C. in one embodiment, from 35° C. to 70° C. in another embodiment and/or from 45° C. to 60° C. in still another embodiment.

Various methods may be used to fabricate insulation products incorporating a rigid polyurethane or polyisocyanurate foam, e.g., a continuous double belt lamination process for making insulated metal panels with a rigid metal facer (such as steel facer) on both the top and bottom surface of the panels; a continuous process of making board stock foam with flexible facers, such as aluminum foil or paper and the like, at both sides of the foam; a discontinuous process of making insulation panels or articles of three dimension shape by injecting the reactive formulation into a mold cavity followed by a subsequent curing of the formulation in the mold at a temperature in the range of from 25° C. to 80° C. for a desirable amount of time; and other processes. Skilled artisans may adapt the reaction kinetics of the present information to achieve a best mold filling and foam curing for the most economical manufacturing.

The method that may be used to fabricate insulation products, may be the aforementioned continuous double belt lamination process. This process may include a moving top belt and a bottom belt each with heating elements and pressure mechanisms that transfer heat and pressure to the products between the belts. One of the advantages of using the double belt lamination process and equipment may be its ability to continuously hold the product under heat for a desired period of time and then to cool the product to set in place.

The isocyanate-reactive composition of the present invention for making rigid polyurethane or polyisocyanurate foams provides a rigid foam product having a density of from 20 g/cm³ to 60 g/cm³ in one general embodiment. In exemplary embodiments, the density of the rigid polyurethane or polyisocyanurate foam may be from 25 g/cm³ to 60 g/cm³ in one embodiment, 30 g/cm³ to 60 g/cm³ in another embodiment, 32 g/cm³ to 50 g/cm³ in still another embodiment, and 35 g/cm³ to 50 g/cm³ in yet another embodiment.

The rigid polyurethane or polyisocyanurate foams of the present invention also exhibit several beneficial properties such as: (1) a low thermal conductivity (improved thermal insulation performance); and (2) an increase in mechanical toughness. For example, the foam of the present invention exhibits a low thermal conductivity of no more than 19.5 mW/m-K at 10° C. in one general embodiment, from 16.0 mW/m-K to 19.5 mW/m-K in another embodiment, from 16.0 mW/m-K to 19.2 mW/m-K in still another embodiment; from 17.0 mW/m-K to 19.2 mW/m-K in yet another embodiment, and from 17.0 mW/m-K to 19.0 mW/m-K in even still another embodiment. The insulation performance of rigid foam of the present invention, as measured by thermal conductivity (or “K-factor”), is defined and determined by the procedure described in ASTM C518-04 (2010).

In addition, the foam of the present invention advantageously exhibits a good mechanical toughness, as measured in terms of percentage of friability as defined and determined by the procedure described in ATSM C 421 (2014). For example, in a general embodiment the foam exhibits a tumbling friability of no more than 10%. In exemplary embodiments, the friability of the rigid foam can be in the range of from 0.1% to 10%, from 0.5% to 10%, and/or from 1% to 10%.

The polyurethane foam produced by the process of the present invention can be used in various applications and end uses including for example for thermal insulation applications in the building and construction industry. In addition, the polyurethane foam can be used in coatings, adhesive, paper and packaging applications. And, the polyurethane foam can be used in appliances, refrigerated transport container applications; and the like.

### EXAMPLES

The following examples are presented to further illustrate the present invention in detail but are not to be construed as limiting the scope of the claims. Unless otherwise indicated, all parts and percentages are by weight.

Various terms and designations used in the Inventive Examples (Inv. Ex.) and the Comparative Examples (Comp. Ex.) which follow are explained hereinbelow:

“PUR” stands for polyurethane rigid with reference to a foam.

“PIR” stands for polyisocyanurate rigid with reference to a foam.

“DEG” stands for diethylene glycol.

“PEG” stands for polyethylene glycol.

“FR” stands for flame retardant.

Various ingredients, components, or raw materials used in the Inventive Examples (Inv. Ex.) and the Comparative Examples (Comp. Ex.) which follow are explained herein below:

The following six different types of polyols were used in the Examples:

(1) Polyol A is a polyester polyol that is prepared with the use of an aromatic dicarboxylic acid and a polyglycol such as DEG, PEG200, glycerol, and the like.

(2) Polyol B is a polyester polyol similar to Polyol A.

(3) Polyol C is a polyester polyol similar to Polyol A.

(4) Polyol D is a polyether polyol manufactured by The Dow Chemical Company such as VORATEC™ SD 301.

The characteristics of each of the above six different types of polyols used in the Examples are described in Table I.

TABLE I
Characteristics of Polyols A-D

| Material | Type | Functionality | OH Number | Mn (g/mole) |
|---|---|---|---|---|
| Polyol A | polyester | 2.0 | 220 | 510 |
| Polyol B | polyester | 2.4 | 315 | 427 |
| Polyol C | polyester | 2.7 | 275 | 551 |
| Polyol D | polyether | 3.0 | 156 | 1,080 |

A variety of different types of foaming additives were used in the Examples; and such additives are described in Table II.

TABLE II
Foaming Additives

| | Product Name of | Supplier of |
|---|---|---|
| Foam Additive | Foam Additive | Foam Additive |
| Catalyst A | POLYCAT ™ 46 | Evonik |
| Catalyst B | POLYCAT ™ 5 | Evonik |
| Catalyst C | JEFFCAT ™ ZF 22 | Huntsman |
| Catalyst D | POLYCAT ™ 8 | Evonik |
| Catalyst E | TMR 30 | Evonik |
| Catalyst F | POLYCAT ™ 41 | Evonik |
| Catalyst G | TMR 20 | Evonik |
| Surfactant A | TEGOSTAB ® B 8421 | Evonik |
| Surfactant B | VORASURF ™ DC193 | The Dow Chemical |
| | | Company (Dow) |
| FR Additive A | TEP (triethyl phosphate) | Sigma Aldrich |
| FR Additive B | TCPP (tris(2-chloroisopropyl) | ICL IP |
| | phosphate) | |

Polyisocyanates used in the Examples include: Polyisocyanate A=PAPI™ 580N; and Polyisocyanate B=PAPI™ 27, both are available from The Dow Chemical Company.

Thixotropic additives used in the Examples include: Thixotropic Additive A which is a MFC paste such as EXILVA™ P01V available from Borregaard; and Thixotropic Additive B which is a cellulose nano crystal (CNC) available from CelluForce.

The physical blowing agent used in the Examples and Comparative Examples is cyclopentane.

The foam-forming compositions presented in Tables III and IV are two illustrative systems for the present invention, based on two different polyols packages: (1) 100% polyester polyols and (2) a mixture of polyester and polyether polyols for Tables III and IV, respectively. Thermal conductivity or K-factor are measured at two different temperatures, (1) 50° F. (10° C.), and (2) 20° F. (−6.7° C.), respectively. These two systems were used in the Examples to determine the effective scope of a thixotropic additive.

### General Procedure for Preparing a Foam

Polyol, surfactant, flame retardant, catalyst and water were added into a plastic mixing cup and the plastic cup with its contents was weighed. Then, the cup contents were mixed with a high-speed overhead mixer to provide a “polyol package” (B-Side). A targeted amount of blowing agent was then added into the cup and thoroughly mixed with the polyol package. Subsequently, a desired amount of a polyisocyanate compound, component A (A-side), was added into the formulation mixture in the cup. The resultant complete formulation was immediately mixed with a high-speed overhead mixer at a mixer-speed of 3,000 rpm for 5 s and then the mixed formulation was poured into a preheated mold which was preheated to 55° C. The size of the mold was 5 cm×20 cm×30 cm. The mold was placed vertically along the mold's length direction for foaming The foam was removed from the mold after about 20 min and placed in a lab bench overnight prior to conducting physical properties testing on the resulting foam product.

### Test Measurements

Various tests were performed on the foam-forming composition and foam products made in accordance with the Examples and Comparative Examples described herein.

### Viscosity Measurements

Viscosity measurements on polyols or polyols blend with and without incorporating a thixotropic additive were carried out using an ARES rheometer (TA Instrument) at temperature of 60° C. A 50 mm cup and plate geometry were used for all the rheological measurement. The sample thickness was kept constant at around 1.5 mm Dynamic viscosity data was collected from the frequency of 0.01 rad/s to 100 rad/s at a constant strain of 10%. The ratio of viscosity at 0.1 rad/s and 100 rad/s was calculated and reported: the higher the ratio of viscosity, the more thixotropic characteristics the fluid exhibits.

### Cream Time and Gel Time

Cream time and gel time are determined according to the testing procedure described in ASTM D7487 (2013). The general procedure for the cream time and gel time measurements includes the following: A free rise foam is made by the plastic cup method described in the above “General Procedure for Preparing a Foam”. Using this method, polyols, surfactant, flame retardants, catalysts, and water are weighed into a plastic cup. An overhead mixer is used to mix the polyol compound(s) and other ingredients in the isocyanate-reactive component B (B-side). A proper amount of blowing agent is then added into the cup and thoroughly mixed into the isocyanate-reactive component (B-side). The isocyanate component (A-side) is then added into the cup followed by immediate mixing using an overhead mixer at about 3,000 rpm for 5 s. The recording of time begins when the mixing of isocyanate component and the isocyanate-reactive component mixture is triggered. When the foam-forming formulation in the cup shows a distinct color or appearance change due to the formation of a large number of bubbles or more commonly known as creaming by skilled artisans, the time is recorded as “Cream Time”. The tip of a wood tongue depressor is then dipped into the foam-forming formulation and quickly pulled out to check whether the foaming mixture becomes stringy. The time when the foaming formulation becomes stringy based on the wood tongue depressor test is recorded as “Gel Time”.

### Thermal Conductivity (K-Factor or Lambda Value)

Within 24 hr after the foams were made (and after the foams sat overnight on a laboratory bench), foam square specimens having a size of 20 cm×20 cm×2.5 cm were cut from the interior and middle part of foams. The thermal conductivity (K-factor) of each of the foam specimens was measured at 50° F. (10° C.) for the PIR system (Table III) and 20° F. (−6.7° C.) for the PUR system (Table IV) according to the procedure described in ASTM C518-04 (2010). The accuracy of K-factor measurements is typically within 0.1 mW/m-K. The average of K-factor measurements of at least two foam square specimens tested was reported.

### Foam Density

The density of rigid foam was measured according to the procedure described in ASTM 1622-03 (2008). Samples of the rigid foam were cut into cube specimens having a size of 5 cm×5 cm×5 cm. The samples were weighed and the exact dimension of each sample was measured. Then, the density of the samples was calculated.

### Friability

The friability property of foams was measured by testing foam specimens in a tumbling machine according to the procedure described in ASTM C 421 (2014). The apparatus includes a cubical box of oak wood, having inside dimensions of 7½ inches by 7¾ inches by 7¾ inches (190 mm by 197 mm by 197 mm). The box shaft was motor driven at a constant speed of 60±2 rpm. Twenty-four room-dry, solid oak, ¾± 1/32-inch (19 mm±0.8-mm) cubes were placed in the box with the test foam specimens. The test foam specimens were prepared by cutting molded foams with a fine-tooth saw into 1± 1/16-inch (25.4±1.6-mm) cubes.

### Open Cell Content

The open cell content of rigid PU foam samples was measured in accordance with ASTM D-6226. A pycnometer, AccuPyc 1330 from Micromeretics equipped with a FoamPyc option for calculation of open cell content, was used for this measurement. Five foam specimens having nominal dimensions of 1 inch×1 inch×1 inch (2.54 cm×2.54 cm×2.54 cm) taken from various points of the foam sample were measured. Any foam specimen with obvious defects by visual inspection were eliminated from testing. Prior to the measurement, all foam specimens were conditioned for a minimum of 24 hr at ASTM standard laboratory conditions. The average value of open cell content for each of the foam specimens was reported.

### Examples 1-7 and Comparative Examples A and B: Thixotropic Additive in a PIR System Comparative Example A

In accordance with the “General Procedure for Preparing a Foam” described above, 180 g of foaming mixture were prepared and immediately poured into a vertically standing mold of 5 cm×20 cm×30 cm. For this particular formulation, about 135 g of foaming mixture were poured inside of the mold. The resulting foam was removed from the mold after 20 min and placed on a laboratory bench overnight prior to conducting physical properties testing on the resulting foam product. Foam properties characterization results are summarized in Table III.

### Examples 1-3

Pre-disperse 2 pts of Thixotropic Additive A into 73 pts of Polyol A with a Flack Tek mixer in a three-step mixing procedure including the steps of: (1) adding 2 pts of Thixotropic Additive A into 8 pts Polyol A in a mixing cup and subsequently mixing the resultant mixture with the Flack Tek mixer at 10,000 rpm for 1 min; (2) adding an additional 20 pts of Polyol A into the mixing cup and subsequently mixing for 1 min at 10,000 rpm; and (3) adding another 45 pts of Polyol A into the mixing cup and subsequently mixing for 1 min at 10,000 rpm. The resulting Thixotropic Additive—Polyol mixture is used for preparing foam-forming formulations by following the detailed formulation data described in Table III using a similar protocol as used in Comp Ex A. Foam properties for Inv. Ex 1-3 are summarized in Table III.

### Examples 4 and 5

The protocol of dispersing Thixotropic Additive A into Polyol A and the subsequent foam preparation is replicated as described in Examples 1-3 above except only 1 pts of Thixotropic Additive A is used. Foam properties for Inv. Ex 4 and 5 are reported in Table III.

### Example 6

The protocol of dispersing Thixotropic Additive A into Polyol A and subsequent foam preparation is replicated as described in Examples 1-3 above except only 0.5 pts of Thixotropic Additive A is used. Foam properties for Inv. Ex. 6 are reported in Table III.

### Example 7

Thixotropic Additive B is directly added into the mixture of Polyol A and Polyol B according to the formulation described in Table III, followed by vigorous mixing with a high shear overhead mixer. Other foaming components shown in Example 7 were subsequently added into the Polyol A and B mixture containing Thioxtropic Additive B and thoroughly mixed for making foams. The same protocol as described in Examples 1-3 was used to prepare the foams of Ex 7. Foam properties for the foams of Ex 7 are reported in Table III.

### Comparative Example B

The protocol of dispersing Thixotropic Additive A into Polyol A and subsequent foam preparation is replicated as described in Examples 1-3 above except that 5 pts of Thixotropic Additive A is used. Foam properties for the foams of Comp. Ex. B are reported in Table III.

TABLE III
Formulation Set for Incorporating Thixotropic Additive A and B into a PIR
System

| | Comp. | Inv. | Inv. | Inv. | Inv. | Inv. | Inv. | Inv. | Comp. |
|---|---|---|---|---|---|---|---|---|---|
| | Ex. A | Ex. 1 | Ex. 2 | Ex. 3 | Ex. 4 | Ex. 5 | Ex. 6 | Ex. 7 | Ex. B |
| Raw Materials | (pts) | (pts) | (pts) | (pts) | (pts) | (pts) | (pts) | (pts) | (pts) |
| Polyol A | 75 | 73 | 73 | 73 | 74 | 74 | 74.5 | 75 | 70 |
| Polyol B | 25 | 25 | 25 | 25 | 25 | 25 | 25 | 25 | 25 |
| Thixotropic Additive A | | 2 | 2 | 2 | 1 | 1 | 0.5 | — | 5 |
| Thixotropic Additive B | | | | | | | | 4.5 | |
| Catalyst A | 2.24 | 2.24 | 2.24 | 2.8 | 2.24 | 2.58 | 2.35 | 2.24 | 2.24 |
| Catalyst B | 1.18 | 1.18 | 1.18 | 1.48 | 1.18 | 1.36 | 1.24 | 1.18 | 1.18 |
| Surfactant A | 3.53 | 3.53 | 3.53 | 3.53 | 3.53 | 3.53 | 3.53 | 3.53 | 3.53 |
| F R Additive A | 17.65 | 17.65 | 17.65 | 17.65 | 17.65 | 17.65 | 17.65 | 17.65 | 17.65 |
| Blowing Agent A | 24.71 | 24.71 | 24.71 | 24.71 | 24.71 | 24.71 | 24.71 | 24.71 | 24.71 |
| Water | 0.94 | 0.94 | | | | | | 0.94 | |
| Total amount of B-side | 150.25 | 150.25 | 149.31 | 150.17 | 149.31 | 149.83 | 149.48 | 154.75 | 149.31 |
| Polyisocyanate A | 308.9 | 308.9 | 308.9 | 308.9 | 308.9 | 308.9 | 308.9 | 308.9 | 308.9 |
| Property Results | | | | | | | | | |
| Viscosity Ratio of | ca. 1-2 | 172 | 172 | 172 | 28 | 28 | 15 | 233 | 314 |
| Polyols Mix | | | | | | | | | |
| Cream time (s) | 10 | 12 | 10 | 9 | 12 | 10 | 9 | 9 | 7 |
| Gel time (s) | 30 | 45 | 38 | 33 | 37 | 33 | 33 | 30 | 26 |
| K-factor @10 ° C. | 19.7 | 19.4 | 19.0 | 18.9 | 18.9 | 18.7 | 19.1 | 19.0 | 20.5 |
| (mW/m-K) | | | | | | | | | |
| Open cell content (%) | 6.8 | 3.3 | 4.1 | 2.5 | 2.4 | 2.6 | 3.3 | 3.8 | 9.5 |
| Physical friability (%) | 15 | nm* | nm | 6.1 | nm | 8.7 | nm | nm | nm |

Note for Table III:
*“nm” stands for “not measured” due to a large sample required for this measurement.

The results described in Table III show that the thermal conductivity (or K-factor) of the foams made according to the Inventive Examples is lower than that of the Comparative

Examples. Incorporation of MFC into a rigid PIR foam also seems to reduce the foam's physical friability. This unexpected toughness enhancement of the foam may be attributed to a three-dimensional network similar to the morphology of the MFC incorporated into the foam. In addition, a thixotropic additive may have a beneficial effect of stabilizing bubble formation.

### Comparative Example C and Examples 8 and 9: Thixotropic Additive in a PUR System Comparative Example C

The polyols and additives used in this Comp. Ex. C and used for foam preparation are described in Table IV. The results of the foam properties are also summarized in Table IV.

### Example 8

In this Example 8, 2 pts of Thixotropic Additive A was pre-dispersed into 18 pts of Polyol A with a Flack Tek mixer in a two-step mixing procedure including the steps of:

(1) adding 2 pts of Thixotropic Additive A into 8 pts of Polyol F into a mixing cup and subsequently mixing the resulting mixture with a Flack Tek mixer at 10,000 rpm for 1 min;
(2) adding an additional 10 pts of Polyol A into the mixing cup and subsequently mixing for 1 min at 10,000 rpm. The resulting Thixotropic Additive A—Polyol A mixture was used for preparing foam formulations by following the detailed formulation data described in Table IV. The foam properties for Inv. Ex. 8 are also summarized in Table IV.

### Example 9

In this Inv. Ex. 9, the procedure for Inv. Ex. 8 described in Table IV for making foam samples is replicated for testing except that only 1 pts of Thixotropic Additive A is used. The foam properties for Inv. Ex. 9 are described in Table IV.

TABLE IV
Adding Thixotropic Additive into a Non-Thixotropic PUR System

| | Comp | Inv. | Inv. |
|---|---|---|---|
| | Ex C | Ex 8 | Ex 9 |
| | (pts) | (pts) | (pts) |
| Raw Materials | | | |
| Polyol C | 60 | 60 | 60 |
| Polyol D | 20 | 20 | 20 |
| Polyol A | 20 | 18 | 19 |
| Thixotropic Additive A | | 2 | 1 |
| Catalyst D | 0.4 | 0.4 | 0.4 |
| Catalyst F | 1 | 1 | 1 |
| Catalyst G | 0.4 | 0.4 | 0.4 |
| Surfactant B | 2.5 | 2.5 | 2.5 |
| FR Additive B | 10 | 10 | 10 |
| Blowing Agent A | 9.2 | 9.2 | 9.2 |
| Water | 5.6 | 4 | 4.8 |
| Total amount of B-side | 129.1 | 127.5 | 128.3 |
| Polyisocyanate B | 216.2 | 216.2 | 216.2 |
| Property Results | | | |
| Viscosity Ratio of Polyols Mix | 6.5 | 113 | 38 |
| Gel Time (sec) | 65 | 78 | 72 |
| Tack Free Time (sec) | 175 | 190 | 195 |
| K-factor at 20° F. (mW/m-K) | 19.73 | 18.72 | 19.01 |
| Open cell content (%) | 6.2% | 4.7% | 4.3% |

The results described in Table IV show that an incorporation of thixotropic additive is beneficial for foam properties improvement such as K-factor when a mixture of polyols with high OH functionality and low OH functionality is used, as long as the mixture of polyols do not already exhibit strong shear thinning behavior.

The polyols used in the Examples described in Tables III and IV are polyester polyols and a mixture of polyester polyols and polyether polyol. When comparing the data of the different foaming systems within each individual Table III and IV, it can be concluded that a thixotropic additive is effective in both foaming systems as long as the average hydroxyl functionality of all polyols combined in the isocyanate-reactive composition is no more than 3.0.

What is claimed is:

1. An isocyanate-reactive composition comprising:
(i) at least one isocyanate-reactive compound; and
(ii) a predetermined amount of at least one thixotropic modifier; wherein the flow characteristic of the at least one thixotropic modifier is such that the isocyanate-reactive composition has a shear thinning behavior characterized by the ratio of viscosities of the isocyanate-reactive composition measured at 60° C. and a shear rate of 0.1 rad/s and 100 rad/s lying between 10 and 300.

2. The composition of claim 1, wherein the at least one thixotropic modifier is a microfibrillated cellulose, nanocellulose, cellulose ether, starch, associative polymers; and mixtures thereof.

3. The composition of claim 1, wherein the amount of the at least one thixotropic modifier is from 0.01 parts by weight to 5 parts by weight based on the total weight of total isocyanate-reactive compounds at 100 parts by weight in the isocyanate-reactive composition, component (B).

4. The composition of claim 1, wherein the at least one isocyanate-reactive compound is selected from the group consisting of a polyether polyol, a polyester polyol, a polycarbonate polyol, and mixtures thereof.

5. The composition of claim 1, wherein the at least one isocyanate-reactive compound includes one or more polyol compounds and the total average hydroxyl functionality of all of the polyols combined present in the isocyanate-reactive composition is less than 3.

6. The composition of claim 1, wherein the at least one isocyanate-reactive compound includes one or more polyol compounds and the total average hydroxyl functionality of all of the polyols combined present in the isocyanate-reactive composition is from 1.8 to 2.7.

7. A foam-forming composition for producing a polyurethane foam or a polyisocyanurate foam comprising:
(A) at least one isocyanate component; and
(B) at least one isocyanate-reactive component; wherein the at least one isocyanate-reactive component is the isocyanate-reactive composition of claim 1.

8. The foam-forming composition of claim 7, further including a surfactant, a catalyst, a physical blowing agent, a chemical blowing agent, a flame retardant additive, a nucleating agent, or mixtures thereof.

9. The composition of claim 7, wherein the at least one isocyanate component, component (A), is at least one aromatic-based isocyanate compound; or wherein the at least one isocyanate component, component (A), is a blend of (1) at least one aromatic-based isocyanate compound and (2) at least one aliphatic-based isocyanate compound.

10. A process for producing a foam-forming composition for producing a polyurethane foam or a polyisocyanurate foam comprising admixing:
(A) at least one isocyanate component; and
(B) at least one isocyanate-reactive component; wherein the at least one isocyanate-reactive component is the isocyanate-reactive composition of claim 1.
